(19) United States
(12) Patent Application Publication
(10) Pub. No.: US 2021/0125815 A1
(43) Pub. Date: Apr. 29, 2021

(54) MASS SPECTROMETRY DEVICE, IMAGE GENERATION METHOD AND IMAGE GENERATION PROGRAM

(71) Applicant: SHIMADZU CORPORATION, Kyoto-shi (JP)

(72) Inventors: Tatsuki OKUBO, Kyoto-shi (JP); Chisato MIYAKE, Kyoto-shi (JP); Yuko OHASHI, Kyoto-shi (JP); Tomonori OSHIKAWA, Kyoto-shi (JP); Ritsuko YODA, Kyoto-shi (JP)

(73) Assignee: SHIMADZU CORPORATION, Kyoto-shi (JP)

(21) Appl. No.: 17/078,344

(22) Filed: Oct. 23, 2020

(30) Foreign Application Priority Data
Oct. 25, 2019 (JP) 2019-194355

(51) Int. Cl. H01J 49/00; H01J 49/16; G06T 11/00

(52) U.S. Cl. CPC H01J 49/0004; H01J 49/0036; G06F 3/14; G06T 11/001; H01J 49/164

(57) ABSTRACT

A mass spectrometry device includes: an image generation unit that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion.

### INCORPORATION BY REFERENCE

The disclosure of the following priority application is herein incorporated by reference: Japanese Patent Application No. 2019-194355 filed Oct. 25, 2019

### TECHNICAL FIELD

The present invention relates to a mass spectrometry device, an image generation method and an image generation program.

### BACKGROUND ART

In mass spectrometry, a sample is ionized by Laser Desorption/Ionization (LDI) such as Matrix Assisted Laser Desorption/Ionization (MALDI). Advantages in MALDI include enabling quick and simple mass spectrometry, as well as obtaining a mass spectrum that is easy to be analyzed since monovalent ions are easily generated. Therefore, it is widely applied to detection of biomarkers and the like (see Non-Patent Literature 1 (NPTL1)).

In MALDI, a mass spectrometry sample, which is crystal of the sample and a matrix, is formed on a sample plate for MALDI, and ionization is performed by irradiating a laser light. On the sample plate for MALDI, tens to hundreds for example (such as, 96 or 396) sample mounting portions are formed. Therefore, it may not be easy to understand arrangement of the mass spectrometry samples on the sample mounting portions, in such a case where the number of sample mounting portions is large, for example. Further, when preparing a mass spectrometry sample, a solution containing the sample is dropped onto a sample plate for MALDI, however there is a possibility that the sample is mistakenly dropped onto a wrong position.

Image showing the arrangement of multiple samples are used. As an example other than the mass spectrometry device, in Patent Literature 1 (PTL1), the analysis direction of a sample in a Liquid Chromatograph (LC) analysis system is indicated by an arrow outside the image showing the arrangement of the sample.

### CITATION LIST

### Patent Literature

PTL 1: Japanese Patent No. 6264997

### Non-Patent Literature

NPTL1: Akinori Nakamura, Naoki Kaneko, Victor L. Villemagne, Takashi Kato, James Doecke, Vincent Dore, Chris Fowler, Qiao-Xin Li, Ralph Martins, Christopher Rowe, Taisuke Tomita, Katsumi Matsuzaki, Kenji Ishii, Kazunari Ishii, Yutaka Arahata, Shinichi Iwamoto, Kengo Ito, Koichi Tanaka, Colin L. Masters, Katsuhiko Yanagisawa “High performance plasma amyloid-β biomarkers for Alzheimer's disease” Nature, (GB), Nature Publishing Group, Feb. 8, 2018, Volume 554, Issue 7691, pp. 249-254

### SUMMARY OF INVENTION

### Technical Problem

In Laser Desorption/Ionization, it is preferable to show samples arranged on sample mounting portions of a sample plate in an easy-to-understand manner to a user, an analyzing person, or the like.

### Solution to Problem

The present invention according to a 1st aspect relates to a mass spectrometry device, comprising: an image generation unit that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion.

The present invention according to a second aspect relates to an image generation method comprising: generating an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion.

The present invention according to a third aspect relates to an image generation program that causes a processing device to perform image generation processing that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion.

### Advantageous Effects of Invention

According to the present invention, in Laser Desorption/Ionization, samples arranged on sample mounting portions of a sample plate can be shown to the user, the analyzing person, or the like in an easy-to-understand manner.

### BRIEF DESCRIPTION OF DRAWINGS

FIG. 1 is a conceptual diagram showing a configuration of a mass spectrometry device according to one embodiment.

FIG. 2 is a conceptual diagram showing an example of a sample arrangement image.

FIG. 3 is a conceptual diagram showing a part of the sample arrangement image.

FIG. 4 is a flowchart showing a flow of a mass spectrometry method according to the embodiment.

FIG. 5 is a conceptual diagram showing an example of a sample arrangement image of a Variation.

FIG. 6 is a conceptual diagram showing a group display element.

FIG. 7 is a conceptual diagram for explaining provision of program.

### DESCRIPTION OF EMBODIMENTS

Hereinafter, embodiments for carrying out the present invention will be described with reference to the drawings.

### First Embodiment

The first embodiment describes a mass spectrometry device that generates an image showing mass spectrometry samples that are arranged on sample mount portions of a sample plate for Matrix Assisted Laser Desorption/Ionization (MALDI). The generated image is referred to as a sample arrangement image in the following embodiments. The sample plate for MALDI refers to a plate-shaped member on which sample(s) for mass spectrometry for being irradiated with a laser light in MALDI is arranged, and is hereinafter referred to as a sample plate for MALDI.

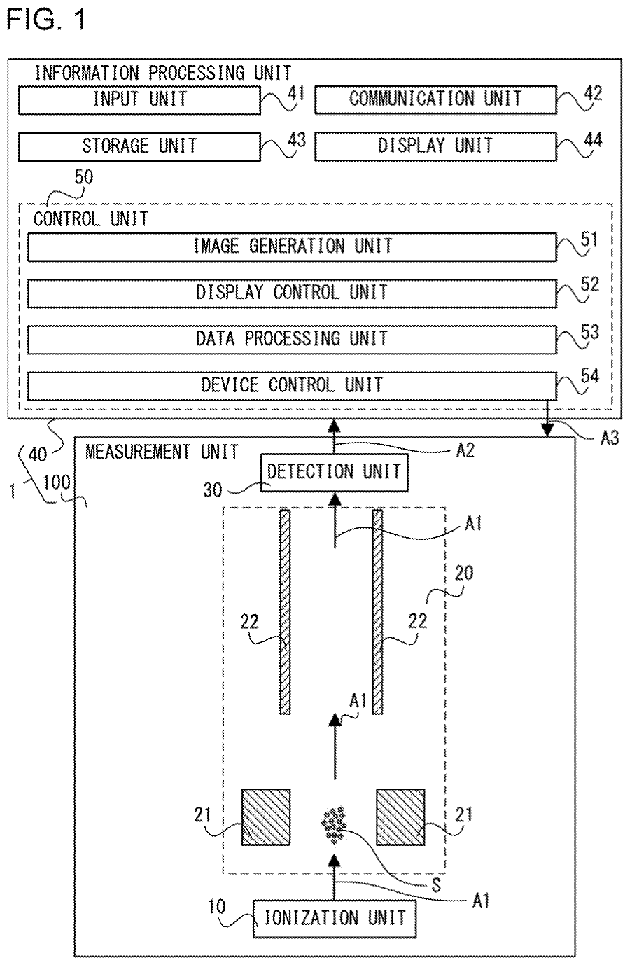

FIG. 1 is a conceptual diagram showing the configuration of the mass spectrometry device 1. The mass spectrometry device 1 is a MALDI mass spectrometry device including an ion source for MALDI. The mass spectrometry device 1 includes a measurement unit 100 and an information processing unit 40.

The measurement unit 100 generates ions derived from the sample (hereinafter, referred to as sample-derived ions S). The measurement unit 100 includes an ionization unit 10, a mass separation unit 20, and a detection unit 30. The mass separation unit 20 includes an ion acceleration unit 21 and a flight tube 22. In FIG. 1, movement of sample-derived ions S is schematically shown by arrows A1.

The information processing unit 40 includes an input unit 41, a communication unit 42, a storage unit 43, a display unit 44, and a control unit 50. The control unit 50 includes an image generation unit 51, a display control unit 52, a data processing unit 53, and a device control unit 54. The flow of the detection signal of the sample-derived ions S output from the detection unit 30 of the measurement unit 100 is schematically shown by the arrow A2. The control of the measurement unit 100 by the device control unit 54 is schematically shown by the arrow A3.

The measurement unit 100 performs mass spectrometry of the sample. In mass spectrometry of the sample, sample-derived ions S are generated by ionization of the mass spectrometry sample prepared from the sample, and the sample-derived ions S are mass-separated and detected.

The ionization unit 10 of the measurement unit 100 includes a sample plate holder (not shown) that supports the sample plate for MALDI. The ionization unit 10 also includes an ion source for MALDI that is provided with both a laser device irradiating the sample plate for MALDI with a laser light, and a laser optical system (these are not shown). The ionization unit 10, under controlling of the device control unit 54 described later, irradiates the mass spectrometry sample with the laser light to ionize it. The ionization unit 10 is configured to be able to scan by the laser light so that the laser light(s) can be irradiated to each sample mounting portion of the sample plate for MALDI. The sample plate for MALDI contains a conductive substance such as metal as a main component. The sample plate for MALDI is made of, for example, stainless steel. The sample-derived ions S generated in the ionization unit 10 move due to an action based on the voltage applied between an extraction electrode (not shown) and the sample plate for MALDI, and then a flow of the ions is appropriately adjusted by a quadrupole or the like and the sample-derived ions S are introduced into the mass separation unit 20.

The sample is not particularly limited as long as it contains a molecule that can be ionized by MALDI. In the present embodiment, the mass spectrometry samples arranged on the sample plate for MALDI are shown to the user of the mass spectrometry device 1 (hereinafter, simply referred to as a user) or an analyzing person in an easy-to-understand manner by means of a sample arrangement image. This makes it easier for the user, the analyzing person, or the like to grasp the arrangement of the mass spectrometry samples. In addition, there are advantages such as suppressing mistakes concerning the dropping position of the sample and performing mass spectrometry more reliably. From this point of view, the larger the number of samples, or the larger the number of mass spectrometry samples prepared from the samples, the greater the effect of this embodiment. For example, in the case of performing detection of a biomarker, in a screening test, it is required to obtain results for many samples efficiently. In clinical practice, such as identification of microorganisms in food poisoning, it is desirable to obtain results promptly before the patient's symptoms worsen. However, the present invention is not limited to such an example, and the number of samples and the number of mass spectrometry samples may be 1 or more in this embodiment.

Preparation of the mass spectrometry sample is performed, for example, as follows. A solution containing a sample and a matrix is obtained by adding a solution containing the matrix (hereinafter referred to as a matrix solution) to a prepared sample or by adding the matrix to a solution containing a sample (hereinafter referred to as a sample solution). The solution containing the sample and the matrix is dropped onto the sample plate for MALDI and dried. By drying, a mass spectrometry sample, which is a crystal of the sample and the matrix is prepared. Alternatively, after placing the sample on the sample plate for MALDI, the matrix solution may be added. Or, the sample solution may be added after the matrix is placed on the sample plate for MALDI. The type of matrix is not particularly limited, and CHCA (α-cyano-4-hydroxycinnamic acid), sinapinic acid or DHB (2,5-dihydroxybenzoic acid), for example, can be used. As a solvent of the matrix solution, for example, a solvent obtained by adding 0 to 3 volume % of trifluoroacetic acid (TFA) to an aqueous solution containing several tens volume % of an organic solvent such as acetonitrile can be used. The mass spectrometry sample may be prepared by further using an arbitrary additive such as MDPNA (Methylenediphosphonic acid).

The mass separation unit 20 of the measurement unit 100 mass-separates the sample-derived ions S. As shown in the example of FIG. 1, it is preferable that the mass separation unit 20 is provided with a time-of-flight mass analyzer in view of accurately mass-separating high-mass molecules such as ones having several thousand kDa or more. The ion acceleration unit 21 of the mass separation unit 20 includes an acceleration electrode. The ion acceleration unit 21 accelerates the sample-derived ions S introduced from the ionization unit 10 by an action based on the voltage applied to the acceleration electrode, and outputs the sample-derived ins S to the flight tube 22. The sample-derived ions S that have flown inside the flight tube 22 enter the detection unit 30.

The detection unit 30 includes an ion detector. For example, in the case where the mass separation unit 20 includes a time-of-flight mass analyzer, the detection unit 30 can include a microchannel plate. The detection unit 30 detects the sample-derived ions S having been mass-separated by the mass separation unit 20, and outputs a detection signal based on the intensity according to the amount of the sample-derived ions S reached the detection unit 30. The detection signal output from the detection unit 30 is analog-to-digital converted (Analog/Digital; A/D), input to the information processing unit 40 (arrow A2), and stored in the storage unit 43. Hereinafter, the data based on the detection signal of the detection unit 30 will be referred to as measurement data.

The information processing unit 40 is provided with an information processing device such as a computer and serves as an interface with a user as appropriate, and also performs processing such as communication, storage, and calculation related to various data.

It is to be noted that the information processing unit 40 may be configured as one device integrated with the measurement unit 100. Further, a part of the data used by the mass spectrometry device 1 may be stored in a remote server or the like.

The input unit 41 of the information processing unit 40 is configured to include an input device such as a mouse, a keyboard, various buttons, or a touch panel. The input unit 41 receives from the user information necessary for controlling the operation of the measurement unit 100, information necessary for processing performed by the control unit 50, and the like.

The communication unit 42 of the information processing unit 40 includes a communication device capable of communicating by wireless or wired connection via a network such as the internet. The communication unit 42 appropriately transmits and receives necessary data.

The storage unit 43 of the information processing unit 40 is configured to include a non-volatile storage medium. The storage unit 43 stores analysis conditions, analysis data, measurement data and a program for the control unit 50 to execute processing, and the like. This program includes an image generation program for generating a sample arrangement image.

The display unit 44 of the information processing unit 40 is configured to include a display device such as a liquid crystal monitor, and displays information related to the measurement of the measurement unit 100 or information obtained by processing of the control unit 50, and the like on the display device.

The control unit 50 of the information processing unit 40 is configured to include a processor such as a central processing unit (CPU) and a storage medium such as a memory, and functions as a center of an operation for controlling the mass spectrometry device 1. The control unit 50 is a processing device that performs processing such as generating a sample arrangement image described later. The control unit 50 performs various processes by loading the program stored in the storage unit 43 or the like into the memory and executing the program.

It should be noted that the physical configuration or the like of the control unit 50 is not particularly limited as long as the processing by the control unit 50 of the present embodiment is possible.

The image generation unit 51 of the control unit 50 generates a sample arrangement image. The sample arrangement image is an image showing a mass spectrometry sample arranged on each sample mounting portion by corresponding the positions of a plurality of sample mounting portions on the sample plate for MALDI with the positions in the sample arrangement image.

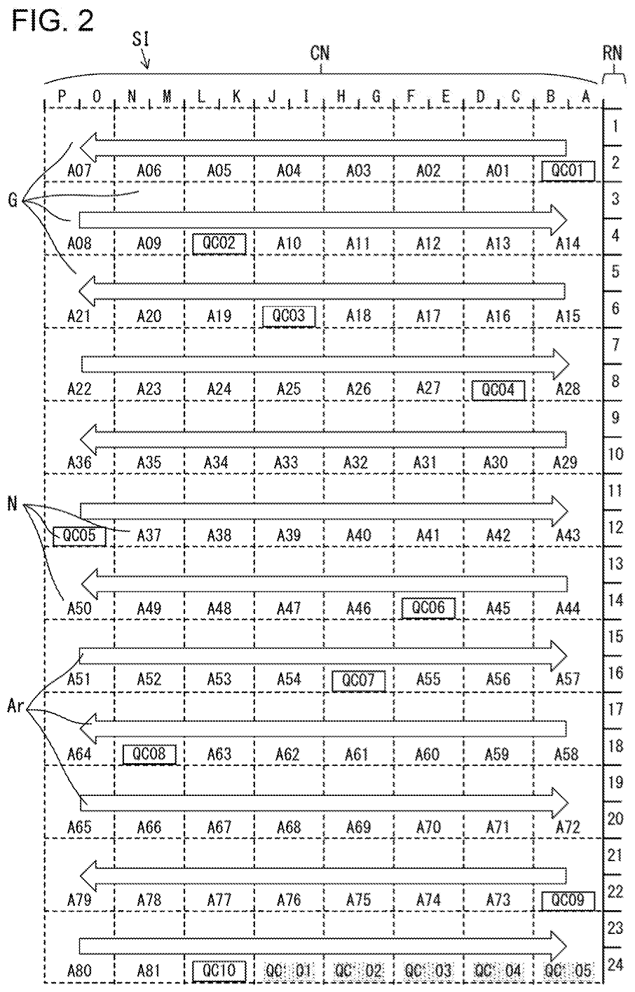

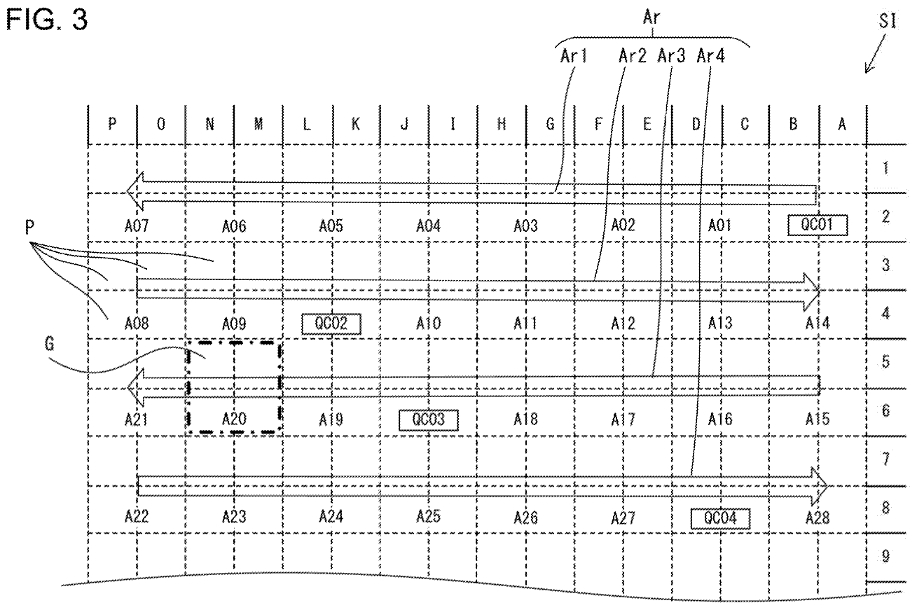

FIG. 2 is a conceptual diagram showing an example of the sample arrangement image in the present embodiment. FIG. 2 is a sample arrangement image SI of the sample plate for MALDI in which 394 sample mounting portions having 24 rows ordered vertically and 16 columns ordered horizontally are arranged at positions corresponding to grid points of a square lattice. The sample arrangement image SI has a configuration in which each position of 394 grid points of the square grid having 24 rows ordered in the vertical direction and 16 columns ordered in the horizontal direction represents the sample mounting portion, corresponding to the arrangement of the sample mounting portions of the sample plate for MALDI. Each display element corresponding to respective sample mounting portion is referred to as a mounting portion display element P. In order that the drawing is easy to see, the mounting portion display elements P are not shown in the sample arrangement image SI of FIG. 2, and they are shown in FIG. 3, which is an enlarged view. In the sample arrangement image SI, the position of the individual sample mounting portion is indicated by a row number RN (1 to 24 in the example of FIG. 2) and a column number CN (A to P in the example of FIG. 2).

It is to be noted that, in the example of FIG. 2, the row number RN is shown on the right side of the sample arrangement image SI, and the column number CN is shown on the upper side. However, the present invention is not particularly limited to this. The row number RN may be shown on the left side or both left and right sides of the sample arrangement image SI, and the column number CN may be shown on the lower side or both the upper and lower sides of the sample arrangement image SI. In the sample arrangement image SI, the row number RN and the column number CN do not necessarily have to be displayed.

In FIG. 2 and FIG. 3, an example is shown that in which mass spectrometry samples prepared from a sample collected from the same person are arranged on four sample mounting portions in two rows ordered vertically and two columns ordered horizontally. One group consisting of a plurality of sample mounting portions as described above is to be called as a sample mounting group. It is preferable that a plurality of mass spectrometry samples prepared from the same sample or from samples which are collected from the same subject are to be arranged on one sample mounting group. However, the configuration of the sample mounting group can be appropriately determined according to the convenience of the user when arranging the mass spectrometry samples. Moreover, the number of the sample mounting portions included in one sample mounting group is not particularly limited as long as it is 2 or more, and lesser than the total number of sample mounting portions in the sample plate for MALDI. Furthermore, the arrangement of the sample mounting portions included in one sample mounting group is not particularly limited.

In FIG. 2 and FIG. 3, group display elements G indicating the sample mounting groups are shown separated by broken lines. Each position of the sample mounting group on the sample plate for MALDI corresponds to each position of the group display element G corresponding to the same sample mounting group in the sample arrangement image SI. One sample mounting group composed of four sample mounting portions which has two rows ordered vertically and two columns ordered horizontally corresponds to one group display element G composed of four mounting portion display elements P which has two rows ordered vertically and two columns ordered horizontally (See the part surrounded by a dashed-and-dotted line in FIG. 3). In the sample arrangement image SI, 96 group display elements G having 12 rows ordered vertically and 8 columns ordered horizontally are shown. The shape and arrangement of the group display element G can be appropriately set based on the defined sample mounting group.

Arrows Ar are display elements indicating the order in which the laser light is irradiated to the mass spectrometry samples arranged on the sample plate for MALDI. In FIG. 2 and FIG. 3, the arrow Ar indicates the order in which the laser light is irradiated to the sample mounting group with the sample mounting group as one unit. The arrow Ar indicates the order in which the laser light is irradiated by passing through the group display element G corresponding to each sample mounting group in the order in which the laser light is irradiated to each sample mounting group. The arrow Ar indicates the scanning direction of the laser light at the position corresponding to the sample mounting portion.

It is to be noted that, in the examples of arrows Ar in FIG. 2 and FIG. 3, the order in which the laser light is irradiated to each of the four sample mounting portions inside the sample mounting group is not shown. However, the arrow may be used to indicate the order in which the laser light is irradiated to the sample mounting portion, with the sample mounting portion as one unit.

For each group display element G, sample information N of the sample mounting group corresponding to the group display element G is shown. The sample information N is information indicating a mass spectrometry sample. The sample information N is not particularly limited as long as it is information that can specify the mass spectrometry sample to at least to some extent. The sample information N can be a name of the mass spectrometry sample, a name of the sample from which the mass spectrometry sample is derived, or information indicating a subject from which the sample was collected. The name may include an identification number, a symbol, or the like.

In the example of FIG. 2, the name of the sample corresponding to each group display element G is shown as the sample information N. In this example, the sample information N such as A01 and A02 in which a number follows A is the name of the sample to be analyzed. Sample information N, such as QC01 and QC02, in which a number follows QC is the name of a control sample for inspecting the accuracy of analysis. The control sample is a sample for examining whether or not the analysis conditions have changed by comparing the average value such as the arithmetic mean of the detection intensities calculated for a plurality of the control samples with the average value in other analyses. The control sample can include, for example, a molecule contained in or expected to be contained in the sample, or a molecule structurally similar to this molecule or a molecule having the same type in structure (peptide, lipid, etc.) as this molecule. It is to be noted that the sample information N may be displayed for each mounting portion display element P corresponding to the sample mounting portion.

In view of inspecting the accuracy of analysis, it is preferable that the control sample is measured every time a predetermined number of samples to be analyzed are measured. FIG. 2 shows a case where the control sample QC01 is first measured, and then the control sample is measured every time nine sample mounting groups to be analyzed are measured. In this example, in order to shorten the scanning path and perform efficient measurement, the scanning direction of the laser light, in the case of the sample mounting group being regarded as one unit, is alternately repeated leftward and rightward in the figure for each row. Although, at a glance, the control samples QC01, QC02, QC03, QC04, QC05, QC06, QC07, QC08, and QC09 appear to be arranged disjointedly, this is because the scanning direction of the laser light is different for each row. In the present embodiment, the orientation of the scanning of the laser light is shown in the sample arrangement image SI, so that the arrangement of the mass spectrometry samples on the sample plate for MALDI can be easily understood.

Sample information N, such as QC′01 and QC′02, in which a number follows QC′ (bottom of FIG. 2) shows the name of a control sample for acquiring calibration data such as a calibration curve. In FIG. 2, control samples for obtaining calibration data at the last of the analysis are arranged on five group display elements.

In FIG. 2, the sample information N for the control sample for checking the accuracy of the analysis is surrounded by a rectangle. The sample information N for the control sample for obtaining calibration data is hatched. The sample information N for the sample to be analyzed is not attached with rectangular or hatching. As described above, in the sample arrangement image SI, it is preferable that the sample information N is displayed so as to be distinguished based on the type of the sample. In the sample arrangement image SI, it is more preferable to distinguishingly display the sample information N by altering at least one of color phase, brightness, and chroma different. Further, it is more desirable that the background of the group display element G or the mounting portion display element P is color-coded based on the color of a cap of the sample used. Furthermore, in the case where there are samples that differ only in density, it is desirable to express them in shading of color.

In the enlarged view of the sample arrangement image SI of FIG. 3, the mounting portion display element P corresponding to each sample mounting portion is shown separated by a broken line. As the arrows Ar indicating the order in which the laser light is irradiated, the left-pointing arrow Ar1, the right-pointing arrow Ar2, the left-pointing arrow Ar3, and the right-pointing arrow Ar4, are shown in this order from the upper side to the lower side in the figure. In the example of FIG. 3, a broken line that overlaps with the arrow Ar and separates the mounting portion display element P is shown. It is preferable to make at least one of color phase, brightness, and chroma different between the arrow Ar and the broken line because it is easy for the user to see.

It is to be noted that, the sample arrangement image SI is not particularly limited, as long as the order in which the laser light is irradiated to the group display elements G or the mounting portion display elements P is indicated by an arrow based on the correspondence between the position of the sample mounting portion and the position of the group display element G or the mounting portion display element P. For example, the group display element G and the mounting portion display element P may be separated by an arbitrary line other than the broken line. Further, the group display element G and the mounting portion display element P may be shown in any form as long as the correspondence between these positions and the position of the sample mounting portion is shown, and may have any shape.

The display control unit 52 of the control unit 50 controls the display unit 44 and displays an image such as the sample arrangement image SI on the display device of the display unit 44.

The data processing unit 53 of the control unit 50 performs analysis processing of the measurement data. The method of analysis processing is not particularly limited. For example, the data processing unit 53 acquires flight time and intensity of detection signals in the measurement data. The data processing unit 53 converts the flight time into a mass-to-charge ratio based on the calibration data obtained in advance, and creates data corresponding to a mass spectrum in which the mass-to-charge ratio is associated with the intensity of the detection signals. Here, the mass-to-charge ratio is not particularly limited as long as it indicates a ratio of the mass and charge of the ion, and for example, m/z can be used. In addition, the data processing unit 53 can quantify or identify the detected sample-derived ions S.

The device control unit 54 of the control unit 50 controls the operation of each unit of the measurement unit 100 based on the information related to the analysis conditions according to the input or the like from the input unit 41 and on the information stored in the storage unit 43. Upon being input start of analysis by the user via the input unit 41, the device control unit 54 obtains information on which sample mounting portions the mass spectrometry samples to be measured are arranged on, and information related to the order in which the sample mounting portions are irradiated with the laser light. The device control unit 54 controls a laser optical system (not shown) of the ionization unit 10 and irradiates the mass spectrometry samples to be measured with laser light in the above order.

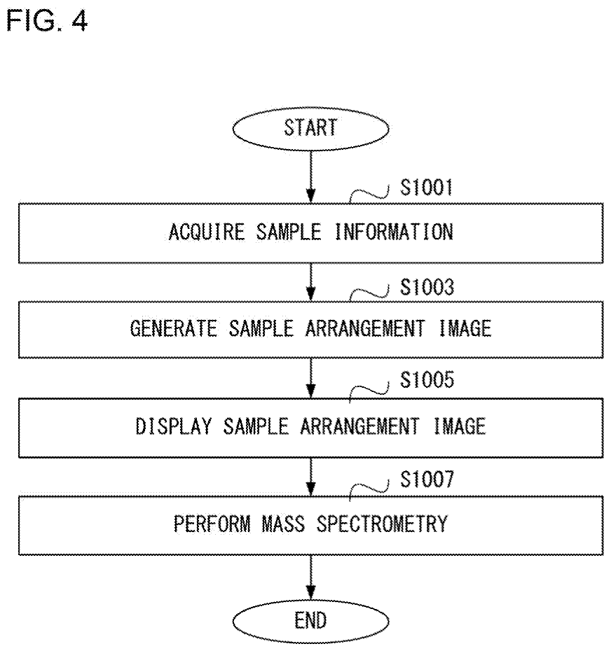

FIG. 4 is a flowchart showing flow of a mass spectrometry method including the image generation method according to the present embodiment. Each step shown in FIG. 4 is preferably performed by the control unit 50. In step S1001, the image generation unit 51 acquires the sample information N. For example, the image generation unit 51 acquires data corresponding to a list in which names of the samples to be analyzed are described in the order of measurement via the input unit 41 or the communication unit 42. In the following, the data corresponding to this list will be referred to as list data. Upon ending step S1001, step S1003 is started.

In step S1003, the image generation unit 51 generates the sample arrangement image SI. For example, the image generation unit 51 adds control samples at the beginning and the end in the above list data, and further adds control samples for each n samples to be analyzed. Here, n is an arbitrary natural number. The image generation unit 51 acquires information on the arrangement of the sample mounting portion on the sample plate for MALDI used in mass spectrometry and information on the sample mounting group. Based on the acquired information, the image generation unit 51 generates data which associates the mass spectrometry samples prepared from the samples described in the list data with the sample mounting portions in which the mass spectrometry samples are to be arranged. The image generation unit 51 sets the order of laser light irradiation and generates the sample arrangement image SI from the generated above data. Upon ending step S1003, step S1005 is started.

In step S1005, the display control unit 52 displays the sample arrangement image SI on the display unit 44. The user sees the sample arrangement image SI, confirms the samples to be measured and the order of measurement, and inputs changes related to these if necessary, via the input unit 41. Upon ending step S1005, step S1007 is started. In step S1007, the control unit 50 performs mass spectrometry. The device control unit 54 controls the measurement unit 100 and performs operations such as ionization, mass separation, and detection. The data processing unit 53 analyzes the measurement data. The display control unit 52 causes the display unit 44 to display information such as a mass spectrum obtained by the analysis. Upon ending step S1007, the process is ended.

The following variations are also within the scope of the present invention and can be combined with the above embodiment or other variations. In the following variations, parts and the like exhibiting the same structure and function as those in the above-described embodiment will be referred to with the same reference signs, and description thereof will be omitted as appropriate.

### Variation 1

In the above-described embodiment, the linear type time-of-flight mass analyzer (FIG. 1) is shown in the mass separation unit 20, however it may be a reflectron type, a multi-turn type, or the like. The method of mass spectrometry is not particularly limited as long as the sample-derived ions S can be separated and detected with a desired accuracy. The mass separation unit 20 can be provided with any one or more mass analyzers such as ion trap and quadrupole mass filter. In the mass separation unit 20, the sample-derived ion S may be dissociated, or an atom or atomic group may be bonded to the sample-derived ion S. Such as fragment ions and adduct ions, generated thereby are also contained in the sample-derived ions S and are mass-separated and detected. The method of dissociation is not particularly limited, and Collision-Induced Dissociation (CID), dissociation by radical, or the like can be appropriately performed.

### Variation 2

In the above-described embodiment, the image generation unit 51 may generate a sample arrangement image showing the sample mounting portion already used in the sample plate for MALDI.

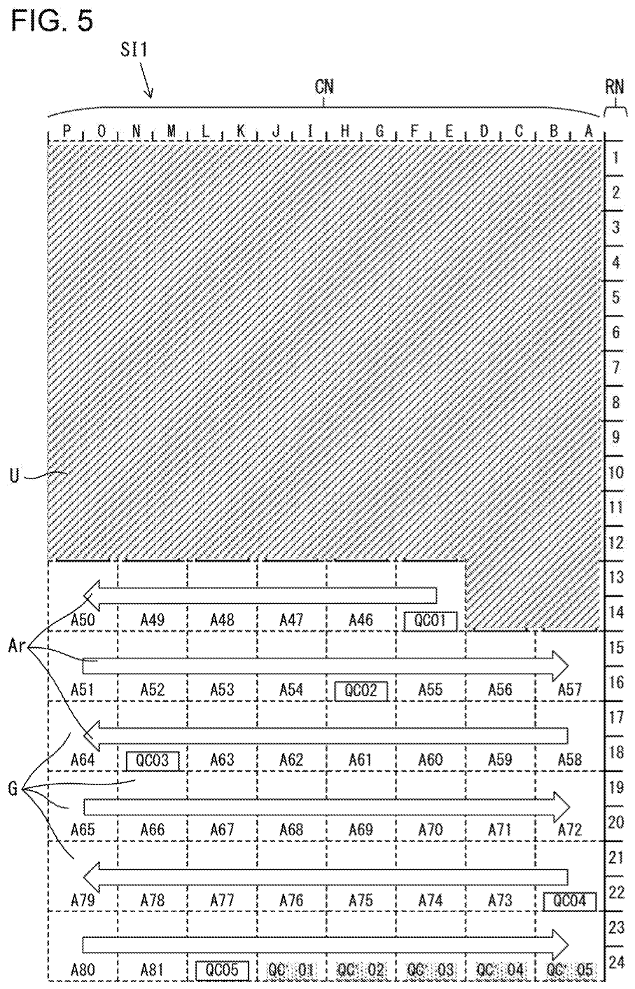

FIG. 5 is a conceptual diagram showing the sample arrangement image SI1 according to the present variation. In the mass spectrometry according to FIG. 5, the measurement of the samples to be analyzed is started from A46. In the sample arrangement image SI1, the already used sample mounting portions are displayed distinctively from the unused sample mounting portions by hatching areas of the sample arrangement image SI1 corresponding to the already used sample mounting portions. Hereinafter, such area is referred to as a used area U. The method for distinguishing the already used sample mounting portion from the unused sample mounting portion is not particularly limited, and for example, at least one of the color phase, brightness, and chroma of the character or background may be different. Alternatively, among the sample mounting portions already used, the last one according to the order of irradiation with the laser light may be distinguished and shown in the same manner as described above.

For example, information indicating the position of the sample mounting portion used in the last mass spectrometry performed by the mass spectrometry device 1 is stored in the storage unit 43. The image generation unit 51 refers to this information from the storage unit 43 and sets the used area U. Since it is not uncommon to use a sample plate for MALDI used immediately before, even with such a configuration, it is possible to indicate in certain level of accuracy the sample mounting portions that has already been used.

It is to be noted that the information of the sample mounting portions already used may be associated with each already used sample plate for MALDI and stored in the storage unit 43.

The display control unit 52 can show the information on the sample mounting portions used in the past mass spectrometry to the user or the analyzing person by displaying the sample arrangement image SD on the display unit 44.

### Variation 3

In the above-described embodiment, when the user sets arrangement of a mass spectrometry sample on the already used sample mounting portion via the input unit 41, the display control unit 52 may be configured to display a warning. The display control unit 52 can acquire information indicating the positions of the already used sample mounting portions in the same manner as in the second variation. The mode of the warning is not particularly limited, but it is preferable to show that the user has set arrangement of a mass spectrometry sample on an unusable sample mounting portion. For example, the display control unit 52 can display characters such as “the input portion has already been used and the sample cannot be arranged” by a pop-up message on the display unit 44. Alternatively, instead of the pop-up message, the characters “error” or the like may be displayed on or near the sample arrangement image SI.

### Variation 4

In the above-described embodiment, the number, position, use, composition, and other aspects of the control samples are not particularly limited. In the above-described embodiment, an example of measuring the sample to be analyzed and the control sample is shown. However, one or more types of samples other than the sample to be analyzed and the control sample may be measured as an alternative to the control sample or in addition to the control sample. The one or more types of samples may also be displayed disinctively from the sample to be analyzed or the control sample. If there is no problem with the accuracy of measurement, only the sample to be analyzed may be performed to mass spectrometry. In each case of this variation, the sample arrangement image SI can show the arrangement of the mass spectrometry samples to the user, the analyzing person, or the like in an easy-to-understand manner.

### Variation 5

In the above-described embodiment, information for distinguishing each sample mounting portion within the sample mounting group may be displayed on each of the mounting portion display elements P corresponding to each sample mounting portion. Numbers, symbols, or the like can be used for this information.

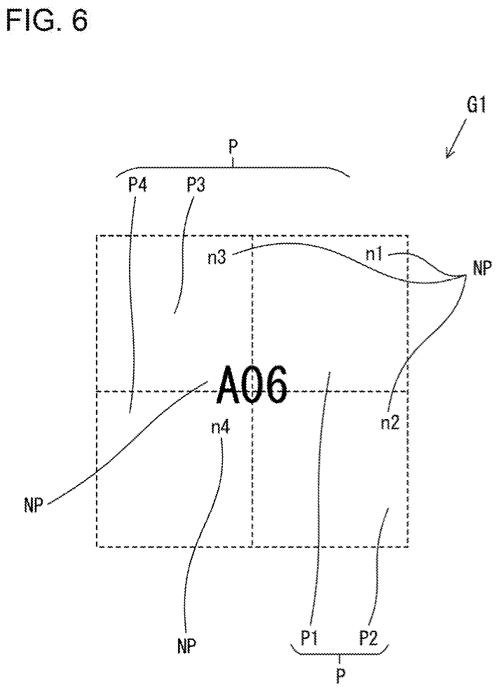

FIG. 6 is a conceptual diagram showing a group display element in the sample arrangement image according to the present variation. The group display element G1 includes four mounting portion display elements P of P1, P2, P3 and P4. In each mounting portion display element P1, P2, P3 and P4, a group internal number NP is indicated at the upper right part thereof. By the group internal number, a position of each sample mounting portion in the entire sample plate for MALDI can be easily associated with a position in the sample mounting group. In FIG. 6, the sample name A06 is shown in the center as an example of the sample information N of the group display element G1.

### Variation 6

In the above-described embodiment, it is configured to show an arrow indicating the order in which the laser light is irradiated at the sample mounting portion. However, it is not limited to the arrow, and any figure such as an arrowhead or a pentagon can be used as long as it is a display element indicating the direction.

### Variation 7

In the above-described embodiment, the sample arrangement image SI showing the arrangement of the mass spectrometry samples in the sample plate for MALDI has been described. However, the sample arrangement image SI is not limited to MALDI, and may indicate the arrangement of the mass spectrometry samples on the sample plate for Laser Desorption/Ionization (LDI). In this case, the image generation unit 51 will be arranged on a control unit of a Laser Desorption/Ionization mass spectrometry device.

### Variation 8

A program for realizing the information processing function of the mass spectrometry device 1 is recorded on a computer-readable recording medium, and the processing by the image generation unit 51 described above and the processing related thereto recorded on the recording medium may be loaded into a computer system and may be executed. It is noted that the term “computer system” in this context may refer to an OS (operating system) or a peripheral device in hardware. In addition, the “computer-readable recording medium” may be a portable recording medium such as a flexible disk, a magneto-optical disk, an optical disk or a memory card, or it may be a storage device such as a hard disk built into the computer system. Furthermore, the “computer-readable recording medium” may be a medium that dynamically holds the program over a short period of time, e.g., a communication line through which the program is transmitted via a network such as the Internet or via a communication network such as a telephone network, or a medium that holds the program over a certain length of time, e.g., a volatile memory within a computer system functioning as a server or a client in the above case. Moreover, the program may allow only some of the functions described above to be fulfilled or the functions described above may be fulfilled by using the program in conjunction with a program pre-installed in the computer system.

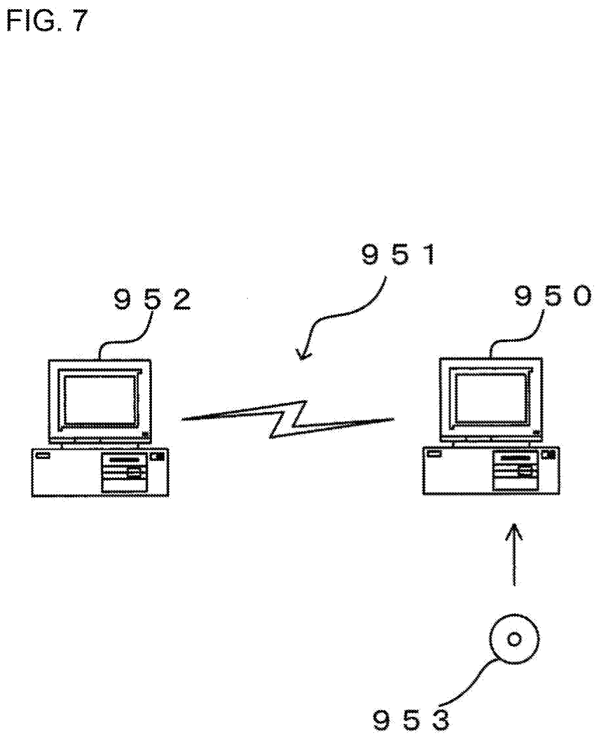

In addition, the present invention may be adopted in conjunction with a personal computer (hereafter referred to as a PC) or the like, and in such a case, the program pertaining to the control described above can be provided in a recording medium such as a CD-ROM or DVD-ROM or on a data signal transmitted through the Internet or the like. FIG. 7 illustrates how such a program may be provided. A PC 950 receives the program via a CD-ROM 953. The PC 950 is also capable of connecting with a communication network 951. A computer 952 is a server computer that provides the program stored in a recording medium such as a hard disk. The communication network 951 may be a communication network such as the Internet or a personal computer communication network, or it may be a dedicated communication network. The computer 952 reads out the program from the hard disk or SSD (Solid State Device) and transmits it to the PC 950 via the communication network 951. In other words, the program may be delivered as a data signal carried on a carrier wave transmitted via the communication network 951. Namely, the program can be distributed as a computer-readable computer program product assuming any of various modes including a recording medium and a carrier wave.

### ASPECTS

It will be understood by those skilled in the art that the above-described plural exemplary embodiments and variations thereof are specific examples of the following aspects.

Item 1

A mass spectrometry device according to one aspect, includes: an image generation unit that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion. Thereby, in laser desorption/ionization, the samples arranged on the sample mounting portions of the sample plate can be easily shown to a user, an analyzing person, or the like.

Item 2

A mass spectrometry device according to another aspect is the mass spectrometry device according to Item 1, wherein: the display element indicates an order in which the mass spectrometry sample is irradiated with laser light in the laser desorption/ionization. Thereby, it is possible to clearly indicate to the user, the analyst, etc. the order of measurement of the samples arranged on the sample mounting portions.

Item 3

A mass spectrometry device according to another aspect is the mass spectrometry device according to Item 1 or Item 2, wherein: the image generation unit groups at least two sample mounting portions into one group, and generates the image indicating mass spectrometry samples arranged on each group so that a position of the group corresponds to a position thereof in the image. Thereby, the samples to be arranged can be shown to the user, the analyzing person, or the like in an easy-to-understand manner for each group of the sample mounting portions.

Item 4

A mass spectrometry device according to another aspect is the mass spectrometry device according to Item 3, wherein: in the image, information indicating a sample from which the mass spectrometry sample is derived is displayed at the position in the image corresponding to the position of each group. Thereby, a derivation of the mass spectrometry sample to be arranged can be shown to the user, the analyzing person, or the like in an easy-to-understand manner for each group of the sample mounting portion.

Item 5

A mass spectrometry device according to another aspect is the mass spectrometry device according to Item 4, wherein: a plurality of mass spectrometry samples prepared from a single sample or samples obtained from a single subject are arranged in the group; and the sample indicating information is information indicating the single sample or the single subject. Thereby, for each group of sample mounting portions, it is possible to clearly indicate to the user, the analyzing person, or the like the sample to be arranged or the subject from which the sample was collected.

Item 6

A mass spectrometry device according to another aspect is the mass spectrometry device according to any one of Items 1 to 5, wherein: in the image, information indicating the mass spectrometry sample or a sample from which the mass spectrometry sample is derived is displayed at the position in the image corresponding to the position of each sample mounting portion. Thereby, it is possible to clearly show the sample to be arranged to the user, the analyzing person, or the like for each sample mounting portion.

Item 7

A mass spectrometry device according to another aspect is the mass spectrometry device according to Item 5 or Item 6, wherein: the sample indicating information includes a name or a type of the sample. Thereby, the name or type of the sample arranged on the sample mounting portion can be indicated in an easy-to-understand manner to the user, the analyzing person, or the like.

Item 8

A mass spectrometry device according to another aspect is the mass spectrometry device according to Item 7, wherein: in the image, the sample indicating information is displayed distinctively based on the type of the sample. Thereby, distribution of each type of sample on the sample plate can be shown in an easy-to-understand manner to the user, the analyzing person, or the like.

Item 9

A mass spectrometry device according to another aspect is the mass spectrometry device according to Item 8, wherein: in the image, the sample indicating information is displayed being different in at least one of color phase, chroma, and brightness based on the type of the sample. Thereby, through the sense of color, distribution of each type of sample on the sample plate can be shown in an easy-to-understand manner to the user, the analyzing person, or the like.

Item 10

A mass spectrometry device according to another aspect is the mass spectrometry device according to any one of Items 1 to 9, further including: a display control unit that displays information related to the sample mounting portion used in past mass spectrometry. Thereby, information related to usable sample mounting portions can be shown to the user, the analyzing person, and the like in an easy-to-understand manner.

Item 11

A mass spectrometry device according to another aspect is the mass spectrometry device according to Item 10, wherein: the display control unit displays a warning when a user inputs a setting for arranging the mass spectrometry sample on the sample mounting portion used in the past mass spectrometry. Thereby, it is possible to suppress misarrangement of the mass spectrometry sample and perform mass spectrometry more reliably.

Item 12

A mass spectrometry device according to another aspect is the mass spectrometry device according to any one of Items 1 to 11, wherein: the laser desorption/ionization is matrix assisted laser desorption/ionization. MALDI is often adopted to measure a large number of samples in such a case as a screening test, and the method of the above-described embodiment is more preferably applied.

Item 13

An image generation method according to one aspect, includes: generating an image indicating a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion. Thereby, in laser desorption/ionization, the samples arranged on the sample mounting portions of the sample plate can be shown in an easy-to-understand manner to the user, the analyzing person, or the like.

Item 14

An image generation program according to one aspect, causes a processing device to perform image generation processing (corresponding to step S1003 in the flowchart of FIG. 4) that generates an image showing a mass spectrometry sample arranged on each sample mounting portion in which each position of a plurality of sample mounting portions in a sample plate for laser desorption/ionization corresponds to each position of the plurality of sample mounting portions in an image, wherein: in the image, a display element indicating a direction is displayed at a position corresponding to the sample mounting portion. Thereby, in laser desorption/ionization, the samples arranged on the sample mounting portions of the sample plate can be shown in an easy-to-understand manner to the user, the analyzing person, or the like.

The present invention is not limited to the contents of the above embodiments. Other modes that are conceivable within the scope of the technical idea of the present invention are also included within the scope of the present invention.

### REFERENCE SIGNS LIST

1 . . . Mass Spectrometry Device, 10 . . . Ionization Unit, 20 . . . Mass Separation Unit, 21 . . . Ion Acceleration Unit, 22 . . . Flight Tube, 30 . . . Detection Unit, 40 . . . Information Processing Unit, 43 . . . Storage Unit, 44 . . . Display Unit, 50 . . . Control Unit, 51 . . . Image Generation Unit, 52 . . . Display Control Unit, 53 . . . Data Processing Unit, 54 . . . Device Control Unit, 100 . . . Measurement Unit, Ar, Ar1, Ar2, Ar3, Ar4 . . . Arrow, CN . . . Column Number, G, G1 . . . Group Display Element, N . . . Sample Information, NP . . . Group Internal Number, P . . . Mounting Portion Display Element, RN . . . Row Number, S . . . Sample-derived Ion, SI, SI1 . . . Sample Arrangement Image.

1. A mass spectrometry device, comprising:
an image generation unit that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein:
in the image, a display element indicating a direction is displayed at a position corresponding to the sample mounting portion.

2. The mass spectrometry device according to claim 1, wherein:
the display element indicates an order in which the mass spectrometry sample is irradiated with laser light in the laser desorption/ionization.

3. The mass spectrometry device according to claim 1, wherein:
the image generation unit groups at least two sample mounting portions into one group, and generates the image indicating mass spectrometry samples arranged on each group so that a position of the group corresponds to a position thereof in the image.

4. The mass spectrometry device according to claim 3, wherein:
in the image, information indicating a sample from which the mass spectrometry sample is derived is displayed at the position in the image corresponding to the position of each group.

5. The mass spectrometry device according to claim 4, wherein:
a plurality of mass spectrometry samples prepared from a single sample or samples obtained from a single subject are arranged in the group; and
the sample indicating information is information indicating the single sample or the single subject.

6. The mass spectrometry device according to claim 1, wherein:
in the image, information indicating the mass spectrometry sample or a sample from which the mass spectrometry sample is derived is displayed at the position in the image corresponding to the position of each sample mounting portion.

7. The mass spectrometry device according to claim 4, wherein:
the sample indicating information includes a name or a type of the sample.

8. The mass spectrometry device according to claim 7, wherein:
in the image, the sample indicating information is displayed distinctively based on the type of the sample.

9. The mass spectrometry device according to claim 8, wherein:
in the image, the sample indicating information is displayed being different in at least one of color phase, chroma, and brightness based on the type of the sample.

10. The mass spectrometry device according to claim 1, further comprising:
a display control unit that displays information related to the sample mounting portion used in past mass spectrometry.

11. The mass spectrometry device according to claim 10, wherein:
the display control unit displays a warning when a user inputs a setting for arranging the mass spectrometry sample on the sample mounting portion used in the past mass spectrometry.

12. The mass spectrometry device according to claim 1, wherein:
the laser desorption/ionization is matrix assisted laser desorption/ionization.

13. An image generation method comprising:
generating an image indicating a mass spectrometry sample arranged on each sample mounting portion in which each position of a plurality of sample mounting portions in a sample plate for laser desorption/ionization corresponds to each position of the plurality of sample mounting portions in an image, wherein:
in the image, a display element indicating a direction is displayed at a position corresponding to the sample mounting portion.

14. An image generation program that causes a processing device to perform image generation processing that generates an image indicating a mass spectrometry sample arranged on each sample mounting portion in which each position of a plurality of sample mounting portions in a sample plate for laser desorption/ionization corresponds to each position of the plurality of sample mounting portions in an image, wherein:
in the image, a display element indicating a direction is displayed at a position corresponding to the sample mounting portion.
